(19) United States
(12) Patent Application Publication
(10) Pub. No.: US 2026/0197479 A1
(43) Pub. Date: Jul. 9, 2026

(54) ENCODER, COMPUTER DEVICE AND NON-VOLATILE COMPUTER-READABLE STORAGE MEDIUM

(71) Applicant: Glenfly Tech Co., Ltd., Shanghai (CN)

(72) Inventors: Chuanchuan ZHU, Shanghai (CN); Cong ZHU, Shanghai (CN); Ao MEI, Shanghai (CN); Jin SHAO, Shanghai (CN); Guodong CHEN, Shanghai (CN)

(21) Appl. No.: 19/209,418

(22) Filed: May 15, 2025

(30) Foreign Application Priority Data
Jan. 7, 2025 (CN) 202510025255.1

(51) Int. Cl. H04N 19/436; H04N 19/105; H04N 19/159; H04N 19/172; H04N 19/52; H04N 19/523; H04N 19/82

(52) U.S. Cl. CPC H04N 19/436; H04N 19/105; H04N 19/159; H04N 19/172; H04N 19/52; H04N 19/523; H04N 19/82

(57) ABSTRACT

An encoder includes a motion estimation module. The motion estimation module includes a first intra prediction unit configured to perform a rough intra prediction on a coding tree unit (CTU), a second intra prediction unit configured to obtain a precise intra-frame coding unit (CU) division result, a first inter prediction unit configured to perform a rough inter prediction on the CTU, an integer pixel prediction unit configured to perform an integer pixel prediction based on the rough inter-frame CU division result, a fractional pixel prediction unit configured to perform a fractional pixel prediction based on an integer pixel prediction result, a second inter prediction unit configured to perform a mode prediction, and a mode selection unit configured to obtain a target prediction mode based on the precise intra-frame CU division result and the precise inter-frame CU division result. At least two of above units perform in parallel.

### CROSS-REFERENCE TO RELATED APPLICATIONS

The present application claims the priority of Chinese Patent Application No. 202510025255.1, filed on Jan. 7, 2025, with the title of “MOTION ESTIMATION MODULE FOR ENCODER AND ENCODER”, the entire content of which is incorporated herein by reference.

### TECHNICAL FIELD

The present application relates to the field of image coding technology, and in particular to an encoder, a computer device and a non-transitory computer-readable storage medium.

### BACKGROUND

With the continuous development of video technology, the resolution of videos is developing towards 4K, 8K and even 16K, and the frame rate is also developing towards 120 fps. With the continuous improvement of resolution and frame rate, the requirements for the processing speed of hardware encoders are also increasing. The encoding speed has become one of the important bottlenecks affecting the performance of hardware video encoders.

For hardware video encoders in the related art, modules are usually executed serially. Especially for motion estimation, since there are many data dependencies during the motion estimation, the entire motion estimation process is almost executed serially. In addition, since a prediction mode selection needs to be made, a large number of logical operations are involved, thus causing the motion estimation to be the most complex and time-consuming part of the video encoder. The motion estimation usually takes 60% to 90% of the time of encoding a frame of image.

### SUMMARY

In a first aspect, the present application provides an encoder. The encoder includes a motion estimation (ME) module, and the ME module includes a first intra prediction unit, a second intra prediction unit, a first inter prediction unit, an integer pixel prediction unit, a fractional pixel prediction unit, a second inter prediction unit, and a mode selection unit.

The first intra prediction unit is configured to perform an intra prediction on a coding tree unit (CTU) to obtain a rough intra-frame coding unit (CU) division result.

The second intra prediction unit is configured to obtain a precise intra-frame CU division result based on the rough intra-frame CU division result.

The first inter prediction unit is configured to perform an inter prediction on the CTU to obtain a rough inter-frame CU division result.

The integer pixel prediction unit is configured to perform an integer pixel prediction based on the rough inter-frame CU division result to obtain an integer pixel prediction result.

The fractional pixel prediction unit is configured to perform a fractional pixel prediction based on the integer pixel prediction result to obtain a fractional pixel prediction result.

The second inter prediction unit is configured to perform a mode prediction based on the fractional pixel prediction result to obtain a precise inter-frame CU division result.

The mode selection unit is configured to obtain a target prediction mode based on the precise intra-frame CU division result and the precise inter-frame CU division result.

At least two of the first intra prediction unit, the second intra prediction unit, the first inter prediction unit, the integer pixel prediction unit, the fractional pixel prediction unit or the second inter prediction unit perform in parallel.

In an embodiment, the first intra prediction unit and the first inter prediction unit are configured to process a coding tree unit CTU[i] in parallel, where i is an integer greater than or equal to 0, and CTU[i] denotes an (i+1)-th CTU.

In an embodiment, the integer pixel prediction unit processing a coding tree unit CTU[i] is in parallel with the first inter prediction unit processing a coding tree unit CTU[i+1].

When the integer pixel prediction unit completes processing each CU in the coding tree unit CTU[i], the first inter prediction unit starts to process a coding tree unit CTU[i+2], where i is an integer greater than or equal to 0, and CTU[i] denotes an (i+1)-th CTU.

In an embodiment, the integer pixel prediction unit, the fractional pixel prediction unit and the second inter prediction unit perform in parallel and process one CU each time.

The fractional pixel prediction unit processing a coding unit CU[j] is in parallel with the integer pixel prediction unit processing a coding unit CU[j+1], and when the fractional pixel prediction unit completes processing the coding unit CU[j], the integer pixel prediction unit starts to process a coding unit CU[j+2].

The second inter prediction unit processing the coding unit CU[j] is in parallel with the fractional pixel prediction unit processing the coding unit CU[j+1], and when the second inter prediction unit completes processing the coding unit CU[j], the fractional pixel prediction unit starts to process the coding unit CU[j+2], where j is an integer greater than or equal to 0, and CU[j] denotes a (j+1)-th CU.

In an embodiment, the second inter prediction unit and the second intra prediction unit process a coding unit CU[j] in parallel, wherein j is an integer greater than or equal to 0, and CU[j] denotes a (j+1)-th CU.

In an embodiment, the ME module further includes at least one of a first storage unit or a second storage unit.

The first storage unit is configured to store the rough intra-frame CU division result obtained by the first intra prediction unit, and supply the rough intra-frame CU division result for the second intra prediction unit to read.

The second storage unit is configured to store the rough inter-frame CU division result obtained by the first inter prediction unit, and supply the rough inter-frame CU division result for the integer pixel prediction unit to read.

In an embodiment, the first inter prediction unit is further configured to determine a search center point of a coding tree unit CTU[i+2], and determine a search range of the coding tree unit CTU[i+2] by taking the search center point as a center, and determine reference pixels within the search range of the coding tree unit CTU[i+2]. Search center points of a first coding tree unit CTU[0] and a second coding tree unit CTU[1] are pre-set respectively, and search ranges of the first coding tree unit CTU[0] and the second coding tree unit CTU[1] are obtained through searching based on the pre-set search center points, respectively, where i is an integer greater than or equal to 0, and CTU[i+2] denotes an (i+3)-th CTU.

In an embodiment, the search center point of the coding tree unit CTU[i+2] is obtained based on an available adjacent motion vector (MV), or the search center point of the coding tree unit CTU[i+2] is obtained based on an MV of a co-located block in an adjacent frame, or the search center point of the coding tree unit CTU[i+2] is obtained based on a global optimal MV determined for each CTU when preprocessing an image.

In an embodiment, determining the search range of the coding tree unit CTU[i+2] by taking the search center point of the coding tree unit CTU[i+2] as the center includes: spreading around by taking the search center point of the coding tree unit CTU[i+2] as the center to form a rectangular area, and determining the rectangular area as the search range of the coding tree unit CTU[i+2].

In an embodiment, the first inter prediction unit, the integer pixel prediction unit, the fractional pixel prediction unit and the second inter prediction unit each determine a motion vector (MV) of a current CU based on an MV of an adjacent CU of the current CU.

The MV of the adjacent CU is determined based on an integer pixel prediction result of the adjacent CU, or the MV of the adjacent CU is determined based on a fractional pixel prediction result of the adjacent CU, or the MV of the adjacent CU is determined based on an MV of a co-located block in an adjacent frame, or the MV of the adjacent CU is an initial MV determined for each CU when preprocessing an image.

In an embodiment, the encoder further includes: a motion compensation and transform quantization module, an entropy coding (EC) module, and an in-loop filter (ILF) module.

The motion compensation and transform quantization module is configured to determine reconstructed pixels and a coding coefficient based on reference pixels, original pixels, and the target prediction mode outputted by the ME module.

The entropy coding (EC) module is configured to generate a coding stream based on the target prediction mode outputted by the ME module and based on the coding coefficient, and the coding stream is stored in a memory.

The in-loop filter (ILF) module is configured to perform an in-loop filtering based on the reconstructed pixels to obtain filtered pixels, and the filtered pixels serve as the reference pixels and are stored in the memory.

At least two of the ME module, the motion compensation and transform quantization module, the EC module, or the ILF module perform in parallel.

In an embodiment, the motion compensation and transform quantization module processing a coding unit CU[j] is in parallel with the second inter prediction unit in the ME module processing a coding unit CU[j+1], or the motion compensation and transform quantization module processing the coding unit CU[j] is in parallel with the first intra prediction unit in the ME module processing the coding unit CU[j+1], where j is an integer greater than or equal to 0, and CU[j] represents a (j+1)-th CU.

In an embodiment, the EC module processing a coding unit CU[j] is in parallel with the motion compensation and transform quantization module processing a coding unit CU[j+1], or the ILF module processing the coding unit CU[j] is in parallel with the motion compensation and transform quantization module processing the coding unit CU[j+1], where j is an integer greater than or equal to 0, and CU[j] represents a (j+1)-th CU.

In an embodiment, the entropy coding module processing the coding unit CU[j] is in parallel with the ILF module processing the coding unit CU[j], where j is an integer greater than or equal to 0, and CU[j] represents a (j+1)-th CU.

In an embodiment, the encoder further includes at least one of a first storage module, a second storage module, a third storage module, a fourth storage module, or a fifth storage module.

The first storage module is configured to store pre-read original pixels of the CTU from the memory and send them to the ME module and the motion compensation and transform quantization module.

The second storage module is configured to store a plurality of pre-read reference pixels from the memory and send them to the ME module and the motion compensation and transform quantization module.

The third storage module is configured to buffer data between the ME module and the motion compensation and transform quantization module, and configured for storing the target prediction mode outputted by the ME module.

The fourth storage module is configured to buffer data between the ME module, the motion compensation and transform quantization module and the EC module, and configured to store the target prediction mode outputted by the ME module and the coding coefficient outputted by the motion compensation and transform quantization module.

The fifth storage module is configured to buffer data between the motion compensation and transform quantization module and the ILF module, and configured for storing the reconstructed pixels outputted by the motion compensation and transform quantization module.

In a second aspect, the present application provides a computer device, including a memory and a processor. The memory has a computer program stored thereon, and the processor, when executing the computer program, executes each module of any one of the encoders above.

In a third aspect, the present application provides a non-transitory computer-readable storage medium, having a computer program stored thereon. The computer program, when executed by a processor, executes each module of any one of the encoders above.

In the encoder, the computer device, and the non-transitory computer-readable storage medium, the ME module includes the first intra prediction unit, the second intra prediction unit, the first inter prediction unit, the integer pixel prediction unit, the fractional pixel prediction unit, the second inter prediction unit, and the mode selection unit. The first intra prediction unit is configured to perform an intra prediction on a coding tree unit (CTU) to obtain a rough intra-frame coding unit (CU) division result. The second intra prediction unit is configured to obtain a precise intra-frame CU division result based on the rough intra-frame CU division result. The first inter prediction unit is configured to perform the inter prediction on the CTU to obtain the rough inter-frame CU division result. The integer pixel prediction unit is configured to perform the integer pixel prediction based on the rough inter-frame CU division result to obtain the integer pixel prediction result. The fractional pixel prediction unit is configured to perform the fractional pixel prediction based on the integer pixel prediction result to obtain the fractional pixel prediction result. The second inter prediction unit is configured to perform the mode prediction based on the fractional pixel prediction result to obtain the precise inter-frame CU division result. The mode selection unit is configured to obtain the target prediction mode based on the precise intra-frame CU division result and the precise inter-frame CU division result. At least two of the first intra prediction unit, the second intra prediction unit, the first inter prediction unit, the integer pixel prediction unit, the fractional pixel prediction unit and the second inter prediction unit perform in parallel, and these units performing in parallel can greatly improve the encoding speed of the hardware encoder.

### BRIEF DESCRIPTION OF THE DRAWINGS

In order to illustrate the technical solutions of the embodiments of the present disclosure and the related art more clearly, the drawings needed for describing the embodiments and the related art are briefly described hereinafter. Obviously, the drawings described hereinafter are only some embodiments of the present disclosure. For the ordinary skilled in the art, other drawings may be obtained based on these drawings without creative work.

FIG. 1 is a schematic view showing coding unit (CU) divisions of an encoder according to an embodiment of the present application;

FIG. 2 is a schematic view showing prediction unit (PU) divisions of an encoder according to an embodiment of the present application;

FIG. 3 is a block diagram showing a structure of a motion estimation (ME) module of an encoder according to an embodiment of the present application;

FIG. 4 is a schematic view showing a pipelined execution of units of an ME module of an encoder according to an embodiment of the present application;

FIG. 5 is a flow chart of determining a search range of a coding tree unit (CTU) according to an embodiment of the present application;

FIG. 6 is a schematic view showing a motion vector (MV) unavailable for calculating a search center point of a CTU according an embodiment of the present application;

FIG. 7 is a schematic view showing MVs of adjacent blocks of a current CU according to an embodiment of the present application;

FIG. 8 is a schematic view showing MVs of adjacent blocks of a current CU according to another embodiment of the present application;

FIG. 9 is a schematic view showing a structure of an encoder according to another embodiment of the present application;

FIG. 10 is a schematic view showing a pipelined execution of modules of an encoder according to an embodiment of the present application;

FIG. 11 is a view showing an internal structure of a computer device according to an embodiment of the present application.

### DETAILED DESCRIPTION OF THE EMBODIMENTS

In order to make the objectives, technical solutions and advantages of the present application clearer and better understood, the present application is further described in detail hereinafter in conjunction with the accompanying drawings and embodiments. It should be understood that the specific embodiments described herein are only used to explain the present application but not intended to limit the present application.

For a motion estimation (ME) module of an encoder, following procedures usually need to be completed.

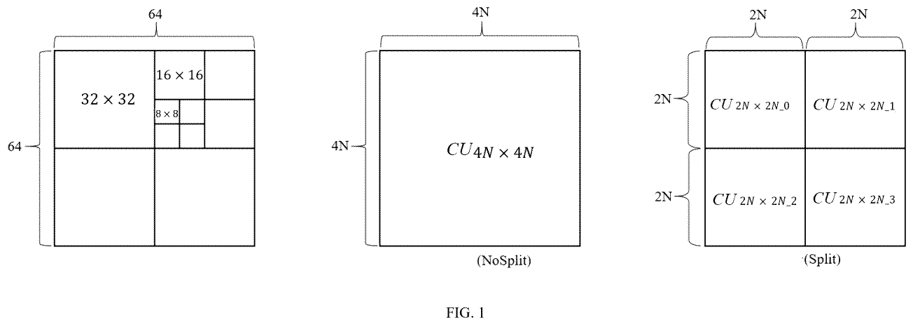

Firstly, it should be determined how to divide a coding tree unit (CTU) into coding units (CUs). According to the High Efficiency Video Coding (HEVC) standard, the maximum size of a CTU is 64×64 pixels, and the size of a CU is 4N×4N pixels, where N=2, 4, 8, or 16. FIG. 1 is a schematic view showing CU divisions of an encoder according to an embodiment of the present application. As shown in FIG. 1, a CTU of 64×64 pixels is divided into a plurality of CUs of 32×32, 16×16, 8×8 pixels.

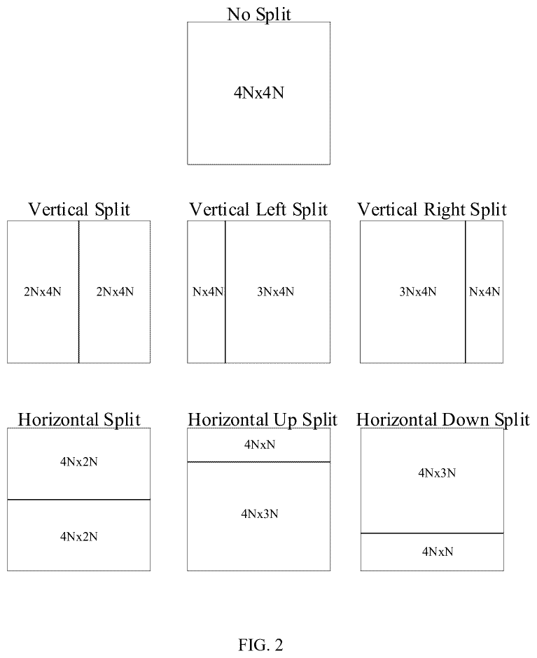

Secondly, it should be determined how to divide a CU into prediction units (PUs). FIG. 2 is a schematic view showing prediction unit (PU) divisions of an encoder according to an embodiment of the present application, as shown in FIG. 2, all possible PU division manners for the CU of 4N×4N pixels are shown.

Thirdly, the optimal prediction mode is found for each PU. The prediction mode includes an intra prediction mode and an inter prediction mode. The intra prediction mode includes various angle prediction modes, and the inter prediction mode includes a normal prediction mode, a Merge prediction mode, and a Skip prediction mode.

A conventional video encoder serially traverses all CU divisions, PU divisions and various prediction modes, and obtains the optimal division manner and prediction mode by calculating the costs of various divisions and various modes. The most accurate division manner and prediction mode can be obtained through this method, thereby ensuring the best quality of the encoded image, but it is difficult to implement the method through hardware and the encoding speed is extremely slow.

The above problem leads to the low encoding speed of existing hardware video encoders. To increase the encoding speed, some encoding tools have to be turned off. Although the encoding speed can be increased in this manner, the quality of the encoded image is poor due to the turning off of some encoding tools, thus making it difficult to ensure the quality of the encoded image and the encoding speed as well.

In view of this, in order to solve the above technical problem, in the present application, it is necessary to provide an encoder that can improve an encoding speed without lowering the quality of the encoded image.

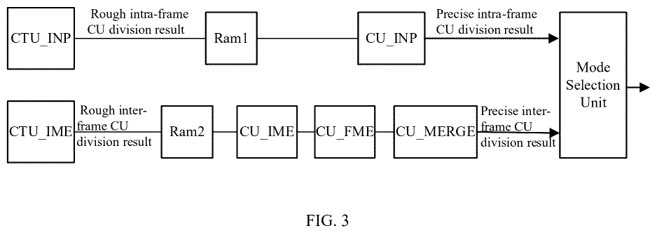

Referring to FIG. 3, FIG. 3 is a block diagram showing a structure of an ME module of an encoder according to an embodiment of the present application. The present application provides an encoder, and the encoder includes an ME module. The ME module includes a first intra prediction unit CTU_INP, a second intra prediction unit CU_INP, a first inter prediction unit CTU_IME, an integer pixel prediction unit CU_IME, a fractional pixel prediction unit CU_FME, a second inter prediction unit CU_MERGE, and a mode selection unit.

The first intra prediction unit CTU_INP is configured to perform an intra prediction on the CTU to obtain a rough intra-frame CU division result. The second intra prediction unit CU_INP is configured to obtain a precise intra-frame CU division result based on the rough intra-frame CU division result. The first inter prediction unit CTU_IME is configured to perform an inter prediction on the CTU to obtain a rough inter-frame CU division result. The integer pixel prediction unit CU_IME is configured to perform an integer pixel prediction based on the rough inter-frame CU division result to obtain an integer pixel prediction result. The fractional pixel prediction unit CU_FME is configured to perform a fractional pixel prediction based on the integer pixel prediction result to obtain a fractional pixel prediction result. The second inter prediction unit CU_MERGE is configured to perform a mode prediction based on the fractional pixel prediction result to obtain a precise inter-frame CU division result. The mode selection unit is configured to obtain a target prediction mode based on the precise intra-frame CU division result and the precise inter-frame CU division result. At least two of the first intra prediction unit CTU_INP, the second intra prediction unit CU_INP, the first inter prediction unit CTU_IME, the integer pixel prediction unit CU_IME, the fractional pixel prediction unit CU_FME or the second inter prediction unit CU_MERGE perform in parallel.

In the application, steps of the ME module of the encoder are reasonably divided into modules. During the motion estimation, a certain method is adopted to eliminate the problem of data dependency between units, so that the units in the ME module can perform in parallel in a pipelined manner, thereby greatly improving the execution speed of the motion estimation.

For ease of understanding, the embodiments of the present application are described in detail in conjunction with Table 1.

TABLE 1
Units in ME module

| Unit | Function |
|---|---|
| First Intra prediction Unit | Performing a rough intra prediction on an entire CTU and |
| CTU_INP | determining an intra-frame CU division of a current CTU |
| First Inter prediction Unit | Performing a rough inter prediction on an entire CTU and |
| CTU_IME | determining an inter-frame CU division of a current CTU |
| Integer Pixel Prediction Unit | Performing an integer pixel motion estimation for a CU |
| CU_IME | |
| Fractional Pixel Prediction | Performing a fractional pixel motion estimation for a CU |
| Unit CU_FME | |
| Second Inter prediction Unit | Performing a Merge/Skip mode motion estimation for a |
| CU_MERGE | CU |
| Second Intra prediction Unit | Performing a precise inter prediction on a CU |
| CU_INP | |
| Mode Selection Unit | Obtaining a target prediction mode base on a precise intra- |
| | frame CU division result and a precise inter-frame CU |
| | division result |

The first intra prediction unit CTU_INP is configured to perform a rough intra prediction on an entire CTU and determine how to divide the current CTU into CUs. The divided CUs are all intra prediction modes, and the prediction result is imprecise. The second intra prediction unit CU_INP will further perform an intra prediction based on the rough intra-frame CU prediction result to obtain a precise intra-frame CU division result, and send the prediction result, i.e., the precise intra-frame CU division result, to the mode selection unit.

The first inter prediction unit CTU_IME is configured to perform a rough inter prediction on the entire CTU and determine how to divide the current CTU into the CUs. The divided CUs are all inter prediction modes, and the prediction result is imprecise. The integer pixel prediction unit CU_IME further performs an inter prediction based on the imprecise inter prediction modes.

The integer pixel prediction unit CU_IME is configured to read the CU prediction result, i.e., the rough inter-frame CU division result, and further perform the integer pixel prediction based on the result, and send the integer pixel prediction result to the fractional pixel prediction unit CU_FME.

The fractional pixel prediction unit CU_FME is configured to receive the integer pixel prediction result from the integer pixel prediction unit CU_IME, and further perform a fractional pixel prediction based on the integer pixel prediction result to obtain the fractional pixel prediction result, and send the fractional pixel prediction result to the second inter prediction unit CU_MERGE.

The second inter prediction unit CU_MERGE is configured to receive the fractional pixel prediction result from the fractional pixel prediction unit CU_FME, and perform, for example, a Merge/Skip prediction mode based on the fractional pixel prediction result to obtain a precise inter-frame CU division result, and send a prediction result, i.e., the precise inter-frame CU division result, to the mode selection unit.

The second intra prediction unit CU_INP is configured to read a rough intra-frame CU prediction result, and further perform an intra prediction based on the result to obtain a precise intra-frame CU division result, and send a prediction result, i.e., the precise intra-frame CU division result to the mode selection unit.

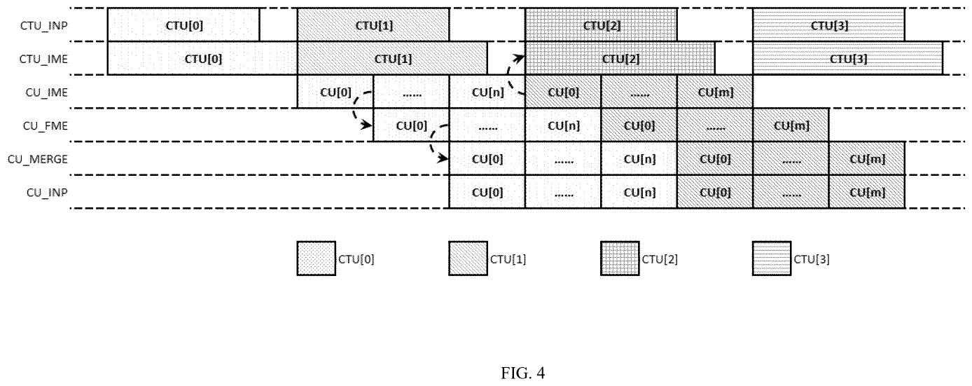

FIG. 4 is a schematic view showing a pipelined execution of units of an ME module of an encoder according to an embodiment of the present application. As shown in FIG. 4, for example, after a rough inter prediction is performed on the first coding tree unit CTU[0] by the first inter prediction unit CTU_IME, the first coding tree unit CTU[0] is divided into n+1 CUs, which are denoted as CU[0] to CU[n], respectively, where CU[n] represents the (n+1)-th coding unit. After the rough inter prediction is performed on the second coding tree unit CTU[1] by the first inter prediction unit CTU_IME, the second coding tree unit CTU[1] is divided into m+1 CUs, which are denoted as CU[0] to CU[m].

In an embodiment, the first intra prediction unit CTU_INP and the first inter prediction unit CTU_IME process the (i+1)-th coding tree unit CTU[i] in parallel, where i is an integer greater than or equal to 0.

Referring to FIG. 4, the first intra prediction unit CTU_INP and the first inter prediction unit CTU_IME are independent of each other, and have the same pipelined priority and perform in parallel.

In an embodiment, the integer pixel prediction unit CU_IME processing the (i+1)-th coding tree unit CTU[i] is in parallel with the first inter prediction unit CTU_IME processing the (i+2)-th coding tree unit CTU[i+1], and when the integer pixel prediction unit CU_IME completes processing each CU in the coding tree unit CTU[i], the first inter prediction unit CTU_IME starts to process the (i+3)-th coding tree unit CTU[i+2], where i is an integer greater than or equal to 0, and CTU[i] denotes the (i+1)-th CTU.

Referring to FIG. 4, the integer pixel prediction unit CU_IME and the first inter prediction unit CTU_IME perform corresponding procedures respectively in parallel in a pipelined manner and process one CTU each time, which is specifically described as follows.

The integer pixel prediction unit CU_IME processing the (i+1)-th coding tree unit CTU[i] is in parallel with the first inter prediction unit CTU_IME processing the (i+2)-th coding tree unit CTU[i+1].

When the integer pixel prediction unit CU_IME completes processing each CU in the coding tree unit CTU[i], the first inter prediction unit CTU_IME starts to process the (i+3)-th coding tree unit CTU[i+2].

In an embodiment, the integer pixel prediction unit CU_IME, the fractional pixel prediction unit CU_FME and the second inter prediction unit CU_MERGE are processing units processing in parallel and processing one CU each time. The fractional pixel prediction unit CU_FME processing the (j+1)-th coding unit CU[j] is in parallel with the integer pixel prediction unit CU_IME processing the (j+2)-th coding unit CU[j+1], and when the fractional pixel prediction unit CU_FME completes processing the (j+1)-th coding unit CU[j], the integer pixel prediction unit CU_IME starts to process the (j+3)-th coding unit CU[j+2]. The second inter prediction unit CU_MERGE processing the (j+1)-th coding unit CU[j] is in parallel with the fractional pixel prediction unit CU_FME processing the coding unit CU[j+1], and when the second inter prediction unit CU_MERGE completes processing the coding unit CU[j], the fractional pixel prediction unit CU_FME starts to process the coding unit CU[j+2], where j is an integer greater than or equal to 0, and CU[j] denotes the (j+1)-th CU.

As shown in FIG. 4, the integer pixel prediction unit CU_IME, the fractional pixel prediction unit CU_FME, and the second inter prediction unit CU_MERGE perform in parallel in a pipelined manner and process one CU each time, which is described specifically as follows.

The (j+1)-th integer-pixel predicted coding unit CU_FME[j] and the (j+2)-th rough inter-frame coding unit CU_IME[j+1] are processed in parallel, that is, the fractional pixel prediction unit CU_FME processing the (j+1)-th coding unit CU[j] is in parallel with the integer pixel prediction unit CU_IME processing the (j+2)-th coding unit CU[j+1].

After the (j+1)-th integer-pixel predicted coding unit CU_FME[j] is processed, the (j+2)-th rough inter-frame coding unit CU_IME[j+2] starts to be processed, that is, when the fractional pixel prediction unit CU_FME completes processing the (j+1)-th coding unit CU[j], the integer pixel prediction unit CU_IME starts to process the (j+3)-th coding unit CU[j+2].

The (j+1)-th fractional-pixel predicted coding unit CU_MERGE[j] and the (j+2)-th integer-pixel predicted coding unit CU_FME[j+I] are processed in parallel, that is, the second inter prediction unit CU_MERGE processing the (j+1)-th coding unit CU[j] is in parallel with the fractional pixel prediction unit CU_FME processing the (j+2)-th coding unit CU[j+1].

After the (j+1)-th fractional-pixel predicted coding unit CU_MERGE[j] is processed, the (j+3)-th integer-pixel predicted coding unit CU_FME[j+2] starts to be processed, that is, when the second inter prediction unit CU_MERGE completes processing the coding unit CU[j], the fractional pixel prediction unit CU_FME starts to process the coding unit CU[j+2].

In an embodiment, the second inter prediction unit CU_MERGE and the second intra prediction unit CU_INP process the (j+1)-th coding unit CU[j] in parallel, where j is an integer greater than or equal to 0.

The second intra prediction unit CU_INP requires a relatively short processing time, and performs in parallel with the second inter prediction unit CU_MERGE. After the second inter prediction unit CU_MERGE completes processing the (k+1)-th fractional-pixel predicted coding unit CU_MERGE[k], the precise inter prediction result of the (k+1)-th coding unit CU[k] and the precise intra prediction result of the (k+1)-th coding unit CU[k] can be obtained at the same time.

In an embodiment, as shown in FIG. 3, the ME module of the encoder of the present application further includes at least one of a first storage unit Ram1 or a second storage unit Ram2. The first storage unit Ram1 is configured to store the rough intra-frame CU division result obtained by the first intra prediction unit CTU_INP, and supply the rough intra-frame CU division result for the second intra prediction unit CU_INP to read. The second storage unit Ram2 is configured to store the rough inter-frame CU division result obtained by the first inter prediction unit CTU_IME, and supply the rough inter-frame CU division result for the integer pixel prediction unit CU_IME to read.

Referring to FIG. 3, the first storage unit Ram1 stores the rough intra-frame CU division result obtained by the first intra prediction unit CTU_INP, so that the subsequent second intra prediction unit CU_INP can read the rough intra-frame CU division result from the first storage unit Ram1.

The second storage unit Ram2 stores the rough inter-frame CU division result obtained by the first inter prediction unit CTU_IME, so that the subsequent integer pixel prediction unit CU_IME can read the rough inter-frame CU division result from the second storage unit Ram2.

The motion module of the encoder of the present application is provided with the first storage unit Ram1 and the second storage unit Ram2, which can prevent the processing progresses of the units of the motion module from blocking each other and can buffer data, thus avoiding the problem of reduced encoding speed due to different processing speeds of the units of the motion module.

In an embodiment, in order to improve the encoding speed of the encoder, the first inter prediction unit CTU_IME of the motion module is further configured to determine a search center point of the coding tree unit CTU[i+2], and determine a search range of the coding tree unit CTU[i+2] by taking the search center point as a center, and then determine reference pixels within the search range of the coding tree unit CTU[i+2]. The search center points of the first coding tree unit CTU[0] and second coding tree unit CTU[1] are pre-set respectively, and the search ranges of the first coding tree unit CTU[0] and second coding tree unit CTU[1] are obtained through searching based on the pre-set search center points, respectively, where i is an integer greater than or equal to 0. In an embodiment of the present application, the search center point of the coding tree unit CTU[i+2] is obtained based on an available adjacent motion vector (MV). Alternatively, the search center point of the coding tree unit CTU[i+2] is obtained based on an MV of a co-located block in an adjacent frame. Alternatively, the search center point of the coding tree unit CTU[i+2] is obtained based on a global optimal MV determined for each CTU when preprocessing the image.

The MVs of the PUs in a CTU are different and correspond to different reference pixels accordingly. If data are read from the memory only when the reference pixels are needed, the encoding speed will be greatly reduced due to a memory delay. In the embodiments of the present application, the search range of each CTU is determined in advance, and the reference pixels within the search range are read in advance from the memory of the encoder.

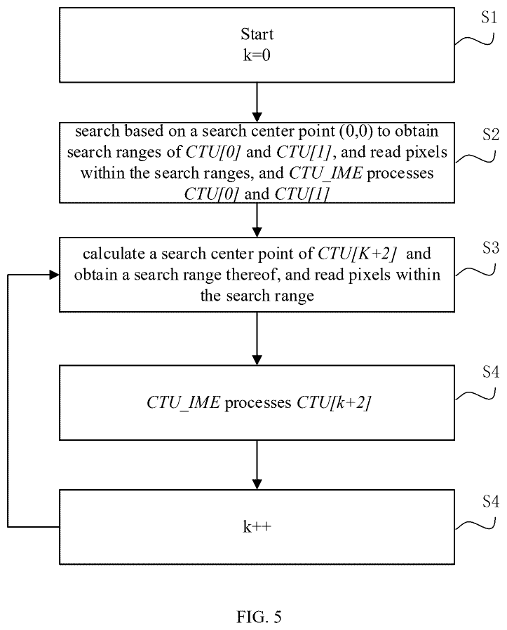

Referring to FIG. 5, FIG. 5 is a flow chart of determining a search range of a CTU according to an embodiment of the present application.

In an embodiment of the present application, determining the search range of the CTU includes the following steps: firstly, determining a search center point for each CTU; secondly, spreading around by taking the search center point of each CTU as a center to form a rectangular area, and determining the rectangular area as the search range of the corresponding CTU. In an embodiment, the size of the rectangular area can be determined by a user or a software configuration. In order to ensure high search accuracy and better quality of the encoded image, the search center point of a CTU is generally determined by an algorithm. Alternatively, the search center point can be determined for the current CTU with reference to the MVs of the adjacent blocks around the current CTU.

As shown in FIG. 5, in step S1, firstly, set k=0. In step S1, an initialization is performed, for example, the search center points of the first coding tree unit CTU[0] and the second coding tree unit CTU[1] are both set as (0,0). In step S2, searches are performed based on the preset search center point (0,0) to obtain the search ranges of the first coding tree unit CTU[0] and the second coding tree unit CTU[1], and the reference pixels within the corresponding search ranges are read, and then the first inter prediction unit CTU_IME processes the first coding tree unit CTU[0] and the second coding tree unit CTU[1]. In Step S3, a search center point of a coding tree unit CTU[k+2] is determined, and a search range of the coding tree unit CTU[k+2] is determined based on the search center point, and the reference pixels within the search range are read. In Step S4, the first inter prediction unit CTU_IME continues to process the coding tree unit CTU[k+2]. In Step S5, the value of k is added by 1, and return to perform step S3 until all CTUs are processed.

In an embodiment, the first inter prediction unit CTU_IME calculates the search range by two CTUs in advance. That is, after processing the (i+1)-th coding tree unit CTU[i], the first inter prediction unit CTU_IME determines the search range of the (i+3)-th coding tree unit CTU[i+2], and reads the reference pixels within the search range from the memory and stores them in the corresponding storage module.

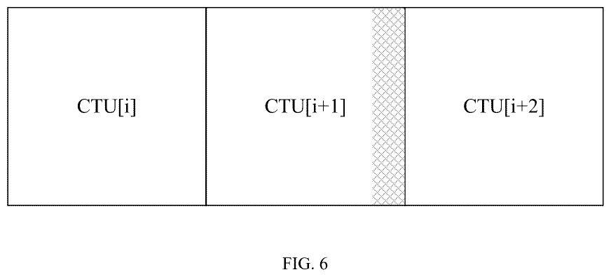

It should be understood that, due to the parallel processing and the advance calculation of the search range of the CTU, the MVs of the adjacent blocks around the CTU are not always available. As shown in FIG. 6, when calculating the search center point of the coding tree unit CTU[i+2], the MVs on its left (i.e., a shaded part in the figure) are not available, because the coding tree unit CTU[i+1] has not started encoding at this time, and no encoding information can be provided as a reference for the coding tree unit CTU[i+2]. In view of this, in an embodiment of the present application, the reference pixels of the coding tree unit CTU[i+] may be determined by at least one of the following manners.

Abandon making reference to unavailable adjacent MVs, and only make reference to available adjacent MVs, for example, make reference to the available adjacent MVs above the coding tree unit CTU[i+2]. Alternatively, make reference to the MVs that are available in a time period adjacent to a time point when the search center point of the coding tree unit CTU[i+2] is calculated, and this method is the simplest, but has a certain influence on the accuracy of the search range of the CTU.

In an embodiment, the ME module of the encoder of the present application may be additionally provided with a video preprocessing module for analyzing a video image in advance, so as to determine the global optimal MV for each CTU.

In an embodiment, the first inter prediction unit CTU_IME, the integer pixel prediction unit CU_IME, the fractional pixel prediction unit CU_FME and the second inter prediction unit CU_MERGE all determine the MV of the current CU based on the MV of an adjacent CU of the current CU. The MV of the adjacent CU is determined based on the integer pixel prediction result of the adjacent CU. Alternatively, the MV of the adjacent CU is determined based on the fractional pixel prediction result of the adjacent CU. Alternatively, the MV of the adjacent CU is determined based on the MV of a co-located block in the adjacent frame. Alternatively, the MV of the adjacent CU is an initial MV determined for each CU when preprocessing the image.

In an embodiment of the present application, when performing an inter prediction, a motion vector list, i.e., an MVP list, needs to be constructed for each PU in the CU. The first inter prediction module CTU_IME, the integer pixel prediction module CU_IME, the fractional pixel prediction module CU_FME, and the second inter prediction module CU_MERGE mentioned in the present application all need to construct an MVP list.

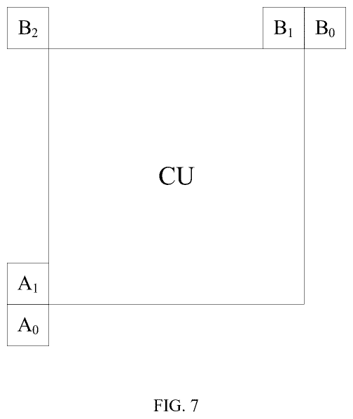

In an embodiment of the present application, when constructing the MVP list for each PU, references are made to the MVs of the adjacent blocks of the current CU. FIG. 7 is a schematic view showing MVs of adjacent blocks of a current CU according to an embodiment of the present application, as shown in FIG. 7, only after the second inter prediction unit CU_MERGE completes performing, can the precise MV of the current CU be obtained.

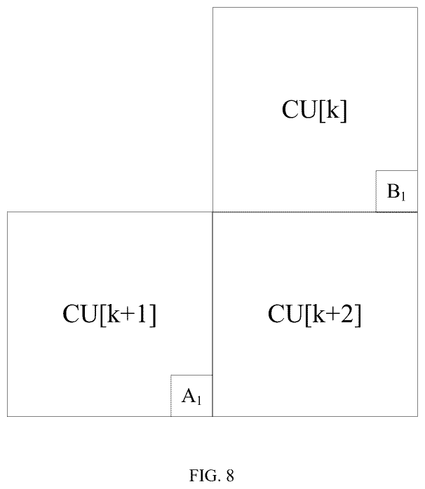

However, due to parallel processing, the MVs of the adjacent blocks around the current CU are not always available, or although there is an available MV, the available MV is not a final precise MV. FIG. 8 is a schematic view showing MVs of adjacent blocks of a current CU according to another embodiment of the present application. Referring to FIG. 8, in an embodiment, when the first inter prediction unit CTU_IME processes the coding tree unit CU[k+2], the fractional pixel prediction unit CU_FME processes the coding tree unit CU[k+1] in parallel. Then the second inter prediction unit CU_MERGE processes the coding tree unit CU[k+] in parallel, and at this time, precise MVs at positions A₁ and B₁ around the coding tree unit CU[k+2] cannot be obtained. In order to solve the above problem, determining the MVs of the adjacent blocks of the current CU includes, but is not limited to, the following methods.

In an embodiment of the present application, when determining an MV of a adjacent block of the current CU, the available imprecise MV of the adjacent block of the current CU may be configured to replace the unavailable precise MV. For example, as shown in FIG. 8, the MV at the position A₁ adjacent to the coding tree unit CU[k+2] is replaced by the prediction result of the position A₁ obtained by the integer pixel prediction unit CU_IME, and the MV at the position B₁ adjacent to the coding tree unit CU[k+2] is replaced by the prediction result of the position B₁ obtained by the integer pixel prediction unit CU_IME or obtained by the fractional pixel prediction unit CU_FME.

Optionally, in an embodiment of the present application, when determining the MV of the adjacent block of the current CU, the unavailable precise MV may be replaced by the MV available in a time period that is adjacent to the time point when the search center point of the coding tree unit CTU[i+2] is calculated.

Optionally, in an embodiment of the present application, in order to determine the MV of the adjacent block of the current CU, the ME module of the encoder may be additionally provided with a video preprocessing module configured to analyze the video image in advance and determine an initial MV for each CU.

The above-mentioned embodiments of the present application adopt a reasonable method to remove the data dependency between previous and next units of the ME module, so that the encoding speed of the encoder can be improved while ensuring the quality of the encoded image of the encoder.

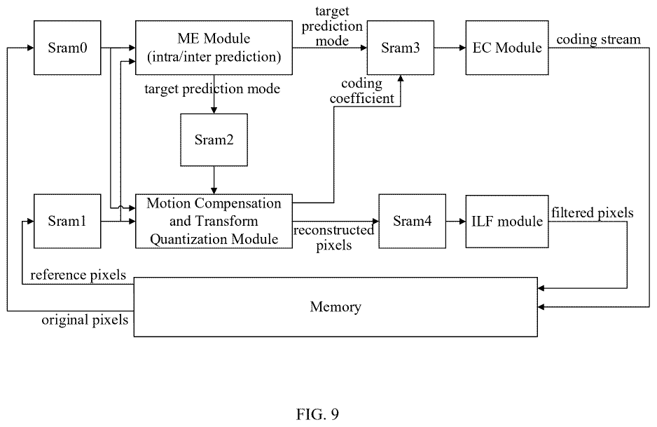

FIG. 9 is a schematic view showing a structure of an encoder according to another embodiment of the present application. As shown in FIG. 9, in an embodiment, the encoder of the present application includes the ME module. The ME module, as described in the above embodiments, includes the first intra prediction unit CTU_INP, the second intra prediction unit CU_INP, the first inter prediction unit CTU_IME, the integer pixel prediction unit CU_IME, the fractional pixel prediction unit CU_FME, the second inter prediction unit CU_MERGE, and the mode selection unit. At least two of the first intra prediction unit CTU_INP, the second intra prediction unit CU_INP, the first inter prediction unit CTU_IME, the integer pixel prediction unit CU_IME, the fractional pixel prediction unit CU_FME, or the second inter prediction unit CU_MERGE perform in parallel. The encoder of this embodiment of the present application also includes: a motion compensation and transform quantization module, an entropy coding module, and an in-loop filter module. The motion compensation and transform quantization module is configured to determine reconstructed pixels and a coding coefficient based on the reference pixels, the original pixels, and the target prediction mode outputted by the ME module. The entropy coding module is configured to generate a coding stream based on the target prediction mode outputted by the ME module and the coding coefficient, and the coding stream is stored in a memory. The in-loop filter module is configured to perform an in-loop filtering based on the reconstructed pixels to obtain filtered pixels, and the filtered pixels serve as reference pixels and are stored in the memory. At least two of the ME module, the motion compensation and transform quantization module, the entropy coding module, or the in-loop filter module perform in parallel.

The motion estimation (ME) module is mainly used for intra-frame and inter predictions to determine the optimal CU division manner, the optimal PU division manner, the MVs and other prediction information. The ME module is the most complex module in the encoder. In the encoding process, the ME module is the most time-consuming module, and the specific limitation thereof can be seen above.

The motion compensation and transform quantization module, denoted as CU_MC, mainly receives the optimal prediction information, i.e., the target prediction mode, sent by the ME module, and obtains information such as predicted pixels, residuals, reconstructed pixels, and an entropy coding coefficient based on the optimal prediction information.

The in-loop filter (ILF) module, denoted as CU_ILF, mainly receives the reconstructed pixels sent by the motion compensation and transform quantization module, filters the reconstructed pixels to obtain the filtered pixels, and then writes the filtered pixels into the memory to serve as reference pixels for subsequent frames.

The entropy coding (EC) module, denoted as CU_EC, mainly receives the coding coefficient sent by the motion compensation and transform quantization module, and the optimal prediction information, i.e., the target prediction mode, sent by the ME module, and then performs entropy coding on the optimal prediction information and the coding coefficient to obtain the final coding stream, and writes the final coding stream into the memory.

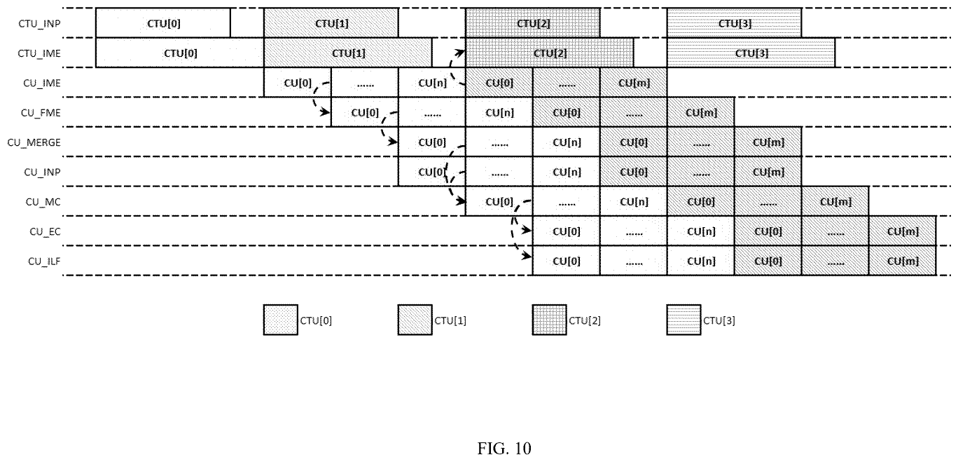

In order to improve the processing efficiency of the encoder, as shown in FIG. 10, at least two of the ME module, the motion compensation and transform quantization module CU_MC, the EC module CU_EC, or the ILF module CU_ILF of the encoder of the present application perform in parallel.

In an embodiment, the motion compensation and transform quantization module CU_MC processing the coding unit CU[j] is in parallel with the second inter prediction unit CU_MERGE in the ME module processing the coding unit CU[j+1]. Alternatively, the motion compensation and transform quantization module CU_MC processing the coding unit CU[j] is in parallel with the first intra prediction unit CTU_INP in the ME module processing the coding unit CU[j+1], where j is an integer greater than or equal to 0, and CU[j] represents the (j+1)-th CU.

Referring to FIG. 10, the motion compensation and transform quantization module CU_MC processing the coding unit CU[j] is in parallel with the second inter prediction unit CU_MERGE or the first intra prediction unit CTU_INP in the ME module processing the coding unit CU[j+1].

In an embodiment, the EC module CU_EC processing the coding unit CU[j] is in parallel with the motion compensation and transform quantization module CU_MC processing the coding unit CU[j+1]. Alternatively, the ILF module CU_ILF processing the coding unit CU[j] is in parallel with the motion compensation and transform quantization module CU_MC processing the coding unit CU[j+1], where j is an integer greater than or equal to 0.

Referring to FIG. 10, the EC module CU_EC or the ILF module CU_ILF processing the coding unit CU[j] is in parallel with the motion compensation and transform quantization module CU_MC processing the coding unit CU[j+1].

In an embodiment of the present application, the EC module CU_EC and the ILF module CU_ILF are independent of each other and there is no data dependency therebetween.

In an optional embodiment, the entropy coding module CU_EC processing the coding unit CU[j] is in parallel with the ILF module CU_ILF processing the coding unit CU[j], where j is an integer greater than or equal to 0.

Referring to FIG. 10, the entropy coding module CU_EC processing the coding unit CU[j] is in parallel with the ILF module CU_ILF processing the coding unit CU[j].

In the above embodiments, based on the HEVC hardware encoder, the hardware encoder of the present application is configured to be a pipelined architecture. When all encoding tools are turned on, the encoding time of the encoder is reduced by 60%, or the encoding speed of the encoder is increased by 150%, which improves the encoding speed while ensuring the quality of the encoded image. In addition, the processing method of the present application is illustrated only by taking the HEVC encoder as an example, and other encoding standards may also adopt the similar pipelined architecture.

In an embodiment, as shown in FIG. 9, the encoder of the present application further includes at least one of the following first to fifth storage modules Sram0-Sram4.

The first storage module Sram0 is configured to store the pre-read original pixels of the CTU and send them to the ME module and the motion compensation and transform quantization module CU_MC.

The second storage module Sram1 is configured to store a plurality of pre-read reference pixels and send them to the ME module and the motion compensation and transform quantization module CU_MC.

The third storage module Sram2 is configured to buffer data between the ME module and the motion compensation and transform quantization module CU_MC, and is configured for storing the target prediction mode outputted by the ME module.

The fourth storage module Sram3 is configured to buffer data between the ME module, the motion compensation and transform quantization module CU_MC and the EC module CU_EC, and is configured to store the target prediction mode outputted by the ME module and the coding coefficient outputted by the motion compensation and transform quantization module CU_MC.

The fifth storage module Sram4 is configured to buffer data between the motion compensation and transform quantization module CU_MC and the ILF module CU_ILF, and is configured for storing reconstructed pixels outputted by the motion compensation and transform quantization module CU_MC.

Continuing to refer to FIG. 10, in the present application, since the ME module, the motion compensation and transform quantization module CU_MC, the EC module CU_EC and the ILF module CU_ILF have certain differences in processing speed, in order to prevent the processing speeds of these four modules from blocking each other, the storage modules Sram0-Sram4 are respectively arranged between any two of these four modules respectively to buffer the data.

Specifically, five storage modules, namely the first storage module Sram0, the second storage module Sram1, the third storage module Sram2, the fourth storage module Sram3, and the fifth storage module Sram4 need to be arranged additionally.

The first storage module Sram0 is configured to store the original pixels read from the memory. The encoder of the present application can read the original pixels of a plurality of CTUs in advance and save them in the first storage module Sram0, so as to prevent the encoding speed of the encoder from being affected by a memory delay caused by real-time reading of the original pixels.

The second storage module Sram1 is configured to store reference pixels read from the memory. The ME module calculates the search ranges of a plurality of CTUs in advance, thus the reference pixels within the search ranges may be read from the memory in advance and saved in the second storage module Sram1, thereby preventing the encoding speed of the encoder from being affected by a memory delay caused by real-time reading of the reference pixels.

The third storage module Sram2 is configured to buffer data between the ME module and the motion compensation and transform quantization module CU_MC, to prevent the processing speed of the motion compensation and transform quantization module CU_MC from being affected by a too slow processing speed of the ME module, or prevent the processing speed of the ME module from being affected by a too slow processing speed of the motion compensation and transform quantization module CU_MC.

The fourth storage module Sram3 is configured to buffer data between the ME module, the motion compensation and transform quantization module CU_MC and the EC module CU_EC, so as to prevent the processing speed of the entropy coding module CU_EC from being affected by too slow processing speeds of the ME module and the motion compensation and transform quantization module CU_MC, or prevent the processing speeds of the ME module and the motion compensation and transform quantization module CU_MC from being affected by a too slow processing speed of the EC module CU_EC.

The fifth storage module Sram4 is configured to buffer data between the motion compensation and transform quantization module CU_MC and the ILF module CU_ILF, to prevent the processing speed of the ILF module CU_ILF from being affected by a too slow processing speed of the motion compensation and transform quantization module CU_MC, or prevent the processing speed of the motion compensation and transform quantization module CU_MC from being affected by a too slow processing speed of the ILF module CU_ILF.

In the embodiments of the present application, the specific specifications of the storage modules Sram0-Sram4 can be determined in advance through experiments, which is not limited in detail in the present application.

The encoder provided in the present application has a pipelined architecture, which greatly improves the encoding speed without changing the quality of the encoded image.

Each module of the above-mentioned encoder may be implemented in whole or in part by software, hardware, or combinations thereof. The modules may be embedded in or independent of a processor of a computer device in a form of hardware, or may be stored in the memory of the computer device in a form of software to facilitate the processor calling and executing the operations corresponding to each of the above modules.

In an embodiment of the present application, a computer device is further provided, including a memory and a processor. A computer program is stored in the memory, and the processor, when executing the computer program, executes each module of the above encoder.

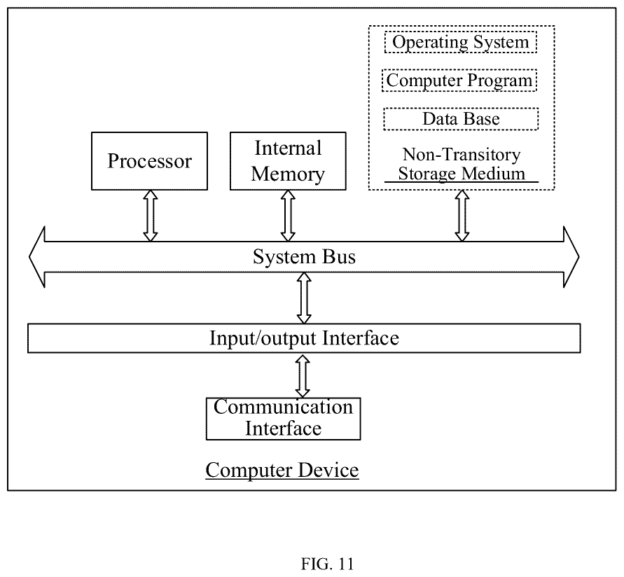

In an embodiment of the present application, the computer device may be a server, and an internal structure diagram thereof may be as shown in FIG. 11. The computer device includes a processor, a memory, an input/output (I/O) interface, and a communication interface. The processor, the memory and the input/output interface are connected via a system bus, and the communication interface is connected to the system bus via the input/output interface. The processor of the computer equipment is configured to provide computing and control capabilities. The memory of the computer equipment includes a non-transitory storage medium and an internal memory. The non-transitory storage medium stores an operating system, a computer program and a database. The internal memory provides an environment for the operation of the operating system and the computer program in the non-transitory storage medium. The database of the computer device is configured to store data. The input/output interface of the computer device is configured to exchange information between the processor and an external device. The communication interface of the computer device is configured to communicate with an external terminal via a network connection. When the computer program is executed by the processor, each module of the encoder is executed.

Those skilled in the art will understand that the structure shown in FIG. 11 is merely a block diagram of a partial structure related to the solution of the present application, and does not constitute a limitation on the computer device to which the solution of the present application is applied. The specific computer device may include more or fewer components than those shown in the figure, or combine certain components, or have a different arrangement of components.

In an embodiment of the present application, a non-transitory computer-readable storage medium is further provided, on which a computer program is stored. The computer program, when executed by a processor, executes each module of the encoder described above in the present application.

It should be understood that, although the steps in the flowcharts involved in the above embodiments are displayed in sequence according to the indication of the arrows, these steps are not necessarily executed in sequence according to the order indicated by the arrows. Unless there is a clear explanation in this article, the execution of these steps is not strictly limited in order, and these steps can be executed in other orders. Moreover, at least a part of the steps in the flowcharts involved in the above embodiments may include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

A person of ordinary skill in the art may understand that implementation of all or part of the procedures of the modules of the encoders in the above embodiments may be completed by instructing the relevant hardware through a computer program. The computer program may be stored in a non-transitory computer-readable storage medium. When the computer program is executed, it may include the procedures of all or part of the modules of the encoders above. Any reference to memory, database or other medium used in the embodiments provided in the present application may include at least one of a non-volatile or a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random-access memory (FRAM), a phase change memory (PCM), or a graphene memory, etc. The volatile memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present application may include at least one of a relational database or a non-relational database. The non-relational database may include, but is not limited to, a blockchain-based distributed database, etc. The processor involved in the embodiments provided by the present application may be, but is not limited to, a general-purpose processor, a central processor, a graphics processor, a digital signal processor, a programmable logic device, a data processing logic device based on quantum computation, an artificial intelligence (AI) processor, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present application, and their description is specific and detailed, but should not be understood as a limitation on the patent scope of the present application. It should be noted that, for those skilled in the art, variations and improvements may be further made without departing from the conception of the present application, and these variations and improvements all fall within the protection scope of the present application. Therefore, the protection scope of the present application should be subject to the appended claims.

What is claimed is:

1. An encoder, comprising a motion estimation (ME) module, wherein the ME module comprises:
a first intra prediction unit, configured to perform an intra prediction on a coding tree unit (CTU) to obtain a rough intra-frame coding unit (CU) division result;
a second intra prediction unit, configured to obtain a precise intra-frame CU division result based on the rough intra-frame CU division result;
a first inter prediction unit, configured to perform an inter prediction on the CTU to obtain a rough inter-frame CU division result;
an integer pixel prediction unit, configured to perform an integer pixel prediction based on the rough inter-frame CU division result to obtain an integer pixel prediction result;
a fractional pixel prediction unit, configured to perform a fractional pixel prediction based on the integer pixel prediction result to obtain a fractional pixel prediction result;
a second inter prediction unit, configured to perform a mode prediction based on the fractional pixel prediction result to obtain a precise inter-frame CU division result; and
a mode selection unit, configured to obtain a target prediction mode based on the precise intra-frame CU division result and the precise inter-frame CU division result;
wherein at least two of the first intra prediction unit, the second intra prediction unit, the first inter prediction unit, the integer pixel prediction unit, the fractional pixel prediction unit or the second inter prediction unit perform in parallel.

2. The encoder according to claim 1, wherein the first intra prediction unit and the first inter prediction unit are configured to process a coding tree unit CTU[i] in parallel, wherein i is an integer greater than or equal to 0, and CTU[i] denotes an (i+1)-th CTU.

3. The encoder according to claim 1, wherein the integer pixel prediction unit processing a coding tree unit CTU[i] is in parallel with the first inter prediction unit processing a coding tree unit CTU[i+1]; and when the integer pixel prediction unit completes processing each CU in the coding tree unit CTU[i], the first inter prediction unit starts to process a coding tree unit CTU[i+2], wherein i is an integer greater than or equal to 0, and CTU[i] denotes an (i+1)-th CTU.

4. The encoder according to claim 1, wherein the integer pixel prediction unit, the fractional pixel prediction unit and the second inter prediction unit perform in parallel and process one CU each time;
the fractional pixel prediction unit processing a coding unit CU[j] is in parallel with the integer pixel prediction unit processing a coding unit CU[j+1], and when the fractional pixel prediction unit completes processing the coding unit CU[j], the integer pixel prediction unit starts to process a coding unit CU[j+2]; and
the second inter prediction unit processing the coding unit CU[j] is in parallel with the fractional pixel prediction unit processing the coding unit CU[j+1], and when the second inter prediction unit completes processing the coding unit CU[j], the fractional pixel prediction unit starts to process the coding unit CU[j+2], wherein j is an integer greater than or equal to 0, and CU[j] denotes a (j+1)-th CU.

5. The encoder according to claim 1, wherein the second inter prediction unit and the second intra prediction unit process a coding unit CU[j] in parallel, wherein j is an integer greater than or equal to 0, and CU[j] denotes a (j+1)-th CU.

6. The encoder according to claim 1, wherein the ME module further comprises at least one of a first storage unit or a second storage unit;
the first storage unit is configured to store the rough intra-frame CU division result obtained by the first intra prediction unit, and supply the rough intra-frame CU division result for the second intra prediction unit to read; and
the second storage unit is configured to store the rough inter-frame CU division result obtained by the first inter prediction unit, and supply the rough inter-frame CU division result for the integer pixel prediction unit to read.

7. The encoder according to claim 1, wherein the first inter prediction unit is further configured to determine a search center point of a coding tree unit CTU[i+2], and determine a search range of the coding tree unit CTU[i+2] by taking the search center point as a center, and determine reference pixels within the search range of the coding tree unit CTU[i+2], wherein search center points of a first coding tree unit CTU[0] and a second coding tree unit CTU[1] are pre-set respectively, and search ranges of the first coding tree unit CTU[0] and the second coding tree unit CTU[1] are obtained through searching based on the pre-set search center points, respectively, wherein i is an integer greater than or equal to 0, and CTU[i+2] denotes an (i+3)-th CTU.

8. The encoder according to claim 7, wherein the search center point of the coding tree unit CTU[i+2] is obtained based on an available adjacent motion vector (MV); or
the search center point of the coding tree unit CTU[i+2] is obtained based on an MV of a co-located block in an adjacent frame; or
the search center point of the coding tree unit CTU[i+2] is obtained based on a global optimal MV determined for each CTU when preprocessing an image.

9. The encoder according to claim 7, wherein determining the search range of the coding tree unit CTU[i+2] by taking the search center point of the coding tree unit CTU[i+2] as the center comprises: spreading around by taking the search center point of the coding tree unit CTU[i+2] as the center to form a rectangular area, and determining the rectangular area as the search range of the coding tree unit CTU[i+2].

10. The encoder according to claim 1, wherein the first inter prediction unit, the integer pixel prediction unit, the fractional pixel prediction unit and the second inter prediction unit each determine a motion vector (MV) of a current CU based on an MV of an adjacent CU of the current CU; and
the MV of the adjacent CU is determined based on an integer pixel prediction result of the adjacent CU; or the MV of the adjacent CU is determined based on a fractional pixel prediction result of the adjacent CU; or the MV of the adjacent CU is determined based on an MV of a co-located block in an adjacent frame; or the MV of the adjacent CU is an initial MV determined for each CU when preprocessing an image.

11. The encoder according to claim 1, further comprising:
a motion compensation and transform quantization module, configured to determine reconstructed pixels and a coding coefficient based on reference pixels, original pixels, and the target prediction mode outputted by the ME module;
an entropy coding (EC) module, configured to generate a coding stream based on the target prediction mode outputted by the ME module and based on the coding coefficient, and the coding stream being stored in a memory; and
an in-loop filter (ILF) module, configured to perform an in-loop filtering based on the reconstructed pixels to obtain filtered pixels, and the filtered pixels serving as the reference pixels and being stored in the memory;
wherein at least two of the ME module, the motion compensation and transform quantization module, the EC module, or the ILF module perform in parallel.

12. The encoder according to claim 11, wherein the motion compensation and transform quantization module processing a coding unit CU[j] is in parallel with the second inter prediction unit in the ME module processing a coding unit CU[j+1]; or the motion compensation and transform quantization module processing the coding unit CU[j] is in parallel with the first intra prediction unit in the ME module processing the coding unit CU[j+1]; wherein j is an integer greater than or equal to 0, and CU[j] represents a (j+1)-th CU.

13. The encoder according to claim 11, wherein the EC module processing a coding unit CU[j] is in parallel with the motion compensation and transform quantization module processing a coding unit CU[j+1]; or the ILF module processing the coding unit CU[j] is in parallel with the motion compensation and transform quantization module processing the coding unit CU[j+1]; wherein j is an integer greater than or equal to 0, and CU[j] represents a (j+1)-th CU.

14. The encoder according to claim 11, wherein the entropy coding module processing the coding unit CU[j] is in parallel with the ILF module processing the coding unit CU[j], wherein j is an integer greater than or equal to 0, and CU[j] represents a (j+1)-th CU.

15. The encoder according to claim 11, further comprising at least one of:
a first storage module, configured to store pre-read original pixels of the CTU from the memory and send them to the ME module and the motion compensation and transform quantization module;
a second storage module, configured to store a plurality of pre-read reference pixels from the memory and send them to the ME module and the motion compensation and transform quantization module;
a third storage module, configured to buffer data between the ME module and the motion compensation and transform quantization module, and configured for storing the target prediction mode outputted by the ME module;
a fourth storage module, configured to buffer data among the ME module, the motion compensation and transform quantization module and the EC module, and configured to store the target prediction mode outputted by the ME module and the coding coefficient outputted by the motion compensation and transform quantization module; or
a fifth storage module, configured to buffer data between the motion compensation and transform quantization module and the ILF module, and configured for storing the reconstructed pixels outputted by the motion compensation and transform quantization module.

16. A computer device, comprising a memory and a processor, wherein the memory has a computer program stored thereon, and the processor, when executing the computer program, executes each module of the encoder according to claim 1.

17. A non-transitory computer-readable storage medium, having a computer program stored thereon, wherein the computer program, when executed by a processor, executes each module of the encoder according to claim 1.
